(19) United States
(12) Patent Application Publication
(10) Pub. No.: US 2026/0257612 A1
(43) Pub. Date: Sep. 3, 2026

(54) LIGHT MODULE FOR MOTOR VEHICLE HEADLIGHT DEVICE

(71) Applicant: VALEO VISION, Bobigny (FR)

(72) Inventor: Laurent MUTHULAR, Bobigny (FR)

(73) Assignee: VALEO VISION, Bobigny (FR)

(21) Appl. No.: 19/165,415

(22) PCT Filed: Mar. 12, 2024
(86) PCT No.: PCT/EP2024/056551

§ 371 Date: Sep. 15, 2025

(30) Foreign Application Priority Data
Mar. 15, 2023 (FR) FR2302411

(51) Int. Cl. B60Q 1/00; F21S 41/19; F21S 41/30; F21S 45/47

(52) U.S. Cl. CPC B60Q 1/0088; F21S 41/19; F21S 41/30; F21S 45/47

(57) ABSTRACT

A light module for a motor vehicle. The light module includes an electrical connection device configured to be arranged in a first position so as to be connected to a power source, and a holding tab configured to reversibly hold the electrical connection device in a second position, in particular during an assembly phase of the light module. The electrical connection device includes a connection member configured to cooperate with the holding tab.

### TECHNICAL FIELD OF THE INVENTION

The invention relates to a luminous module for a headlamp for an automotive vehicle, as well as to a luminous device comprising said module. The invention also relates to a vehicle equipped with a luminous device according to the invention. Finally, the invention relates to a method for assembling the luminous module.

### BACKGROUND OF THE INVENTION

Automotive vehicles are conventionally equipped with luminous devices, such as headlamps, notably front headlamps, or headlights, intended to illuminate the road in front of the vehicle at night or under low light conditions. A luminous device comprises at least one luminous module made up of a luminous source arranged on a printed circuit board and supplied with electrical power by means of an electrical connector.

Conventionally, the electrical connector is arranged in a specific position for the operation thereof, notably in order to allow it to be connected to a power source. For example, in a known manner, the electrical connector can be fixed in the vicinity of a lower zone of the luminous module, in particular to a portion of the module and/or of a plate included in the luminous device, in order to allow electrical connection from the front of said module.

However, such a position of the electrical connector is unsuitable for functional and/or photometric test phases that are usually implemented when assembling the luminous module, particularly at the end of the assembly line. Indeed, connecting and disconnecting a testing machine to the electrical connector requires the electrical connector to be easily accessible by the testing machine. However, this accessibility of the electrical connector to the testing machine is only possible for certain positions of the electrical connector. If the electrical connector is not in one of these positions, then the testing machine cannot reach it, and the test cannot be performed. An operator or a technician then may need to be involved in order to carry out such a testing operation through a manual intervention, which results in a loss of time and an increase in production costs.

### SUMMARY OF THE INVENTION

The present invention falls within this context and aims to propose a luminous module whose architecture is adapted in order to optimize its assembly and the testing phase on an at least partly automated assembly line. In this sense, the invention proposes a luminous module for a luminous device for an automotive vehicle comprising at least one printed circuit board and at least one luminous source arranged on said board. The luminous module comprises at least one electrical connection device configured to be connected to the at least one printed circuit board and comprising a primary connector configured to be movable and arranged in a first operating position so as to be connected to a power source. The luminous module further comprises a support and a holding tab connected to the support and configured to reversibly hold the primary connector in a second position, distinct from the first position, notably during an assembly phase of the luminous module, with the primary connector comprising a connection component configured to cooperate with the holding tab.

Notably, the holding tab is oriented so as to allow access, notably connection, to the primary connector by a testing machine in a first direction when the primary connector is arranged in the second position,
said first direction being distinct from a second direction, corresponding to a direction for accessing the primary connector when the primary connector is arranged in the first position.

Notably, the connection component can comprise a groove or a gutter.

Optionally, the holding tab and the support can be integral. Additionally or alternatively, the luminous module can comprise at least one reflector and/or one heat sink, with the support being selected from among said reflector or said heat sink.

According to one embodiment, the holding tab can be inclined relative to the support.

Optionally, the primary connector can be configured to be mounted in the first position by clipping and/or the primary connector can be configured to be mounted in the second position by sliding in a translation movement.

Notably, the luminous module can comprise an external structure delimiting said module, with the holding tab being arranged and dimensioned so as to extend in a volume delimited by end points of the external structure so as to avoid generating any additional bulk relative to said structure.

According to one embodiment, the electrical connection device can comprise the primary connector, configured to be arranged in the first position or in the second position, and at least one secondary connector configured to be connected to the at least one printed circuit board and connected to the primary connector by means of at least one cable.

The invention also relates to a luminous device for an automotive vehicle, comprising a luminous module according to the invention and a plate configured to support at least said luminous module and to cooperate with the primary connector when the primary connector is arranged in the first position.

The invention also relates to an automotive vehicle comprising a luminous device and/or a luminous module according to the invention.

Finally, the invention relates to a method for assembling a luminous module according to the invention, comprising:
temporarily positioning the primary connector of the electrical connection device in the second position by cooperating between the holding tab and the connection component;
a phase of carrying out one or more functional and/or photometric tests of the operation of the luminous module by connecting a testing machine to the primary connector arranged in the second position;
moving the primary connector from the second position to the first position.

### BRIEF DESCRIPTION OF THE DRAWINGS

Further details, features and advantages will become more clearly apparent upon reading the detailed description that is provided hereafter by way of a non-limiting indication, and with reference to the various embodiments illustrated in the following figures:

FIG. 1 is a schematic view of an embodiment of a vehicle comprising a luminous device equipped with a luminous module;

FIG. 2 is a perspective representation of an embodiment of the luminous module according to the invention in which a connector of an electrical connection device is arranged in a temporary reversible position;

FIG. 3 is a perspective representation of the luminous module according to the invention in which the connector of the electrical connection device is arranged in the reversible temporary position;

FIG. 4 is a schematic representation of the luminous module without the electrical connection device and comprising a holding tab for holding it in the temporary position;

FIG. 5 is a schematic representation of the luminous module viewed from behind showing the positioning of the holding tab;

FIG. 6 is a schematic perspective representation of the cooperation between a body of the electrical connection device and the holding tab;

FIG. 7 is a schematic perspective representation of the connector comprising a connection component capable of cooperating with the holding tab;

FIG. 8 is a schematic cross-sectional representation of the cooperation between the electrical connection device and the holding tab; and

FIG. 9 is a schematic perspective representation of the luminous device in which the connector of the electrical connection device is arranged in a final operating position.

### DETAILED DESCRIPTION OF THE INVENTION

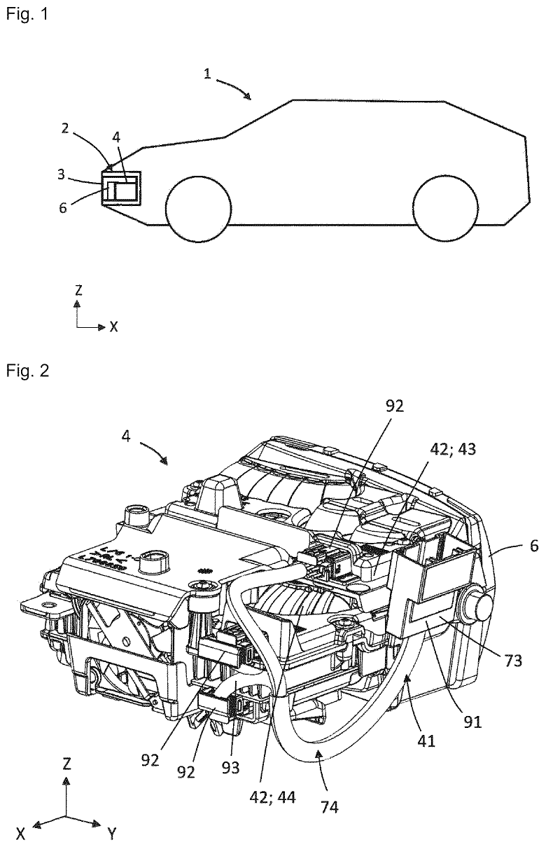

FIG. 1 schematically illustrates an automotive vehicle 1 equipped with a luminous device. In the present case and in a non-limiting manner, the luminous device is a headlamp 2. In the considered example, the headlamp 2 is a front headlamp.

By convention in the following description, the direction in which the automotive vehicle 1 moves in a straight line is defined as being the longitudinal direction X, with the axis representing the longitudinal direction X being oriented from front to back. The direction perpendicular to the longitudinal direction and located in a plane parallel to the ground is called the transverse direction Y. The direction perpendicular to the directions X and Y, in other words, orthogonal to the ground on which the vehicle 1 is standing, is called the vertical direction Z. A direct XYZ coordinate system, which has been shown in the figures requiring it, is thus defined.

Furthermore, the terms “first”, “second”, “primary” and “secondary” are intended to distinguish between similar components and not to establish a hierarchy within said components.

The headlamp 2 comprises a plate 3 and at least one luminous module 4 freely mounted relative to said plate 3 by means of a connection interface. In the illustrated examples, the headlamp 2 comprises a single luminous module 4, it is nevertheless understood that the invention extends to a headlamp 2 comprising a plurality of luminous modules 4. The plate 3 comprises, in a known manner, a plastic material, for example, a plastic material filled with glass fibers such as polybutylene terephthalate, also called PBT.

By way of a non-limiting example, the luminous module 4 can be a module emitting one or more luminous beams, notably so as to emit segmented and/or selectively controllable luminous beams. For example, the luminous module 4 can be used in different modes, such as a “high beam” mode and/or a “low beam” mode, also called “code beam”. The “high beam” mode allows the road far in front of the vehicle 1 to be brightly lit. The “low beam” mode provides more limited lighting of the road, but nevertheless offers good visibility without dazzling other road users.

In general, the luminous module 4 according to the invention comprises at least one printed circuit board and at least one luminous source, not shown. The luminous module 4 also comprises at least one electrical connection device 41 configured to be connected to an electrical power source of the vehicle 1 and to supply electrical power to the at least one printed circuit board and the at least one luminous source. The electrical connection device 41 comprises at least one primary connector 91. Optionally, the electrical connection device 41 can further comprise at least one cable 93 connected to the primary connector 91. The luminous module 4 also comprises, according to the invention, a support 42 and a holding tab 5 connected to said support 42 and configured to reversibly hold the primary connector 91 of the electrical connection device 41, as described in further detail hereafter.

Conventionally, the at least one luminous source is of the semiconductor type, notably of the light-emitting diode type. Optionally, the luminous module 4 can comprise a plurality of selectively activatable luminous sources. The at least one luminous source is arranged on the at least one printed circuit board, or PCB. Notably, the at least one luminous source and the printed circuit board supporting the luminous source are arranged in a rear half, in the longitudinal direction X, of the luminous module 4.

The luminous module 4 also comprises at least one heat sink 43 and at least one reflector 44, assembled so as to define a structure, notably an external structure, comparable to a housing of the luminous module 4. According to embodiments that are described in further detail hereafter, the support 42 of the holding tab 5 is selected from among the at least one heat sink 43 and the at least one reflector 44. According to a non-limiting embodiment, the support 42 can be included in the external structure of the luminous module 4.

The heat sink 43, also referred to as a radiator, is configured to allow the heat emitted by the at least one luminous source equipping the luminous module 4 to be dissipated. For example, the heat sink 43 comprises a metal material such as aluminum. According to a particular, non-limiting embodiment, the luminous module 4 can comprise a plurality of heat sinks 43. The heat sink 43 comprises a plurality of walls at least partly delimiting the external structure of the luminous module 4. For example, the heat sink 43 comprises two lateral walls 43a opposite one another and delimiting the luminous module 4 in the transverse direction Y, as well as an upper wall and a lower wall connecting the lateral walls 43a together.

The at least one reflector 44 is configured to reflect light rays emitted by the at least one luminous source as a luminous beam. For example, the reflector 44 comprises a metal material such as aluminum, or a plastic material such as polycarbonate. For example, the reflector 44 comprises a collector, i.e., a reflecting surface shaped and arranged to collect and reflect light rays, notably comprising a truncated parabolic profile. The reflector 44 cooperates with the at least one heat sink 43 in order to define the structure of the luminous module 4.

The luminous module 4 further comprises a projecting optical unit 6. Conventionally, the optical unit 6 comprises at least one lens configured to project at least one luminous beam originating from the at least one luminous source toward a roadway the vehicle 1 is traveling on. The optical unit 6 is configured to be attached and mounted in the vicinity of a front portion of the luminous module 4. For example, the optical unit 6 is mounted on the at least one heat sink 43.

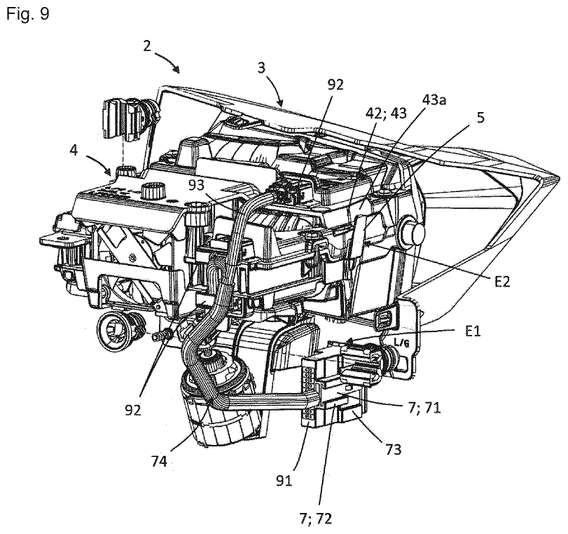

The holding tab 5 according to the invention is configured to reversibly hold the primary connector 91 of the electrical connection device 41. Indeed, conventionally, the primary connector 91 is arranged in the vicinity of a first location E1 in a first position, illustrated in FIG. 9, adapted to allow the luminous module 4 to be connected to the electrical power source when the luminous module 4 is installed in the vehicle 1, notably in the operating situation of the headlamp 2. The illustrated luminous module 4 represents a particular embodiment in which the primary connector 91 arranged in the first position is fixed in the vicinity of a first location E1 located in a lower zone of the luminous module 4 so as to allow electrical connection from the front of said module. In particular, the primary connector 91 can be mounted on a portion of the plate 3 and/or of the external structure of the luminous module 4, for example, on the at least one heat sink 43.

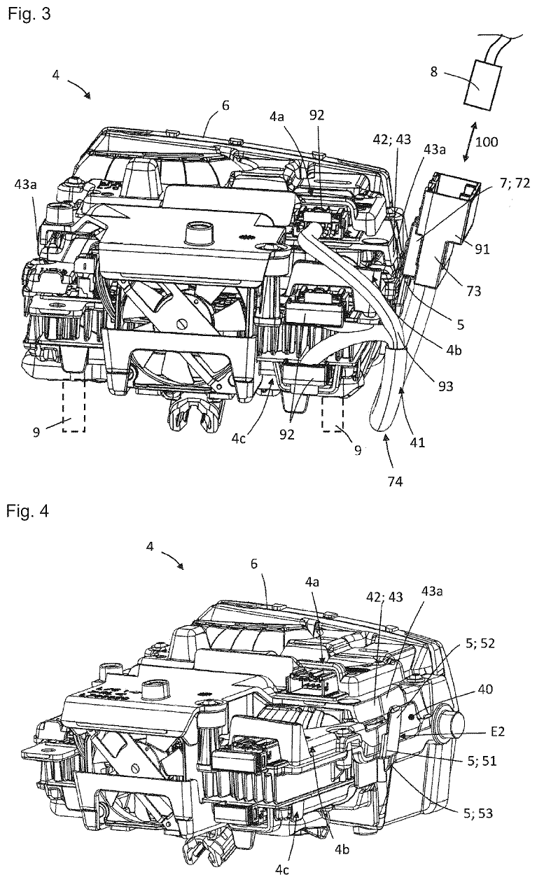

Accessibility to the primary connector 91 is limited when the primary connector is arranged in the first position. In particular, such a position is unsuitable for carrying out the functional and/or photometric tests that are usually implemented during the assembly phase of the luminous module 4, particularly at the end of the assembly line, for example, by means of a testing machine 8, as schematically shown in FIG. 3. Such a disadvantage is notably observed when these tests are executed in an automated manner.

The holding tab 5 advantageously allows the primary connector 91 of the electrical connection device 41 to be reversibly arranged in a second position, distinct from the first position, notably during the assembly phase of the luminous module 4. The term “reversible” means that the second position is temporary and that the electrical connection device 41, particularly the primary connector 91, can be moved from and to the second position as required, without any risk of damaging the luminous module 4, notably the holding tab 5, the support 42 or the primary connector 91 when the primary connector is moved. The primary connector 91 is thus movable, i.e., it can be moved and arranged in either one of the first or second positions.

The holding tab 5 comprises a base 51, where it is connected to the support 42, and a connection segment 52 configured to cooperate with the electrical connection device 41, notably the primary connector 91. The term “segment” is understood herein to mean a part of a whole. Preferably, the holding tab 5, notably the connection segment 52, comprises a straight or substantially straight portion. Optionally, the holding tab 5 comprises at least one reinforcing component 53, for example, arranged in the vicinity of the base 51.

In order to allow the primary connector 91 to be mounted in the second position, the primary connector comprises, as can be seen in FIG. 2, FIG. 3 or FIG. 8, a connection component 7 configured to cooperate with the holding tab 5. For example, the connection component 7 is included in or is arranged in a body 73 of the primary connector 91. Preferably, the connection component 7 and the body 73 are integral. By way of a non-limiting example, the body 73 and/or the connection component comprises a plastic material, notably filled, such as polycarbonate, polybutylene terephthalate, or PBT.

For example, the electrical connection device 41 comprises at least one cable 93 directly or indirectly connected to the luminous module 4, on the one hand, and to the body 73, on the other hand, notably in the vicinity of a connection end of the body 73. Conversely, the connection to the power source or to the testing machine 8 is made in the vicinity of a free end, separate from or opposite the connection end. In this sense, in order to optimize the accessibility to the primary connector 91 when the primary connector is arranged in the second position, the connection component 7 is optionally arranged so as to be closer to the connection end than to the free end.

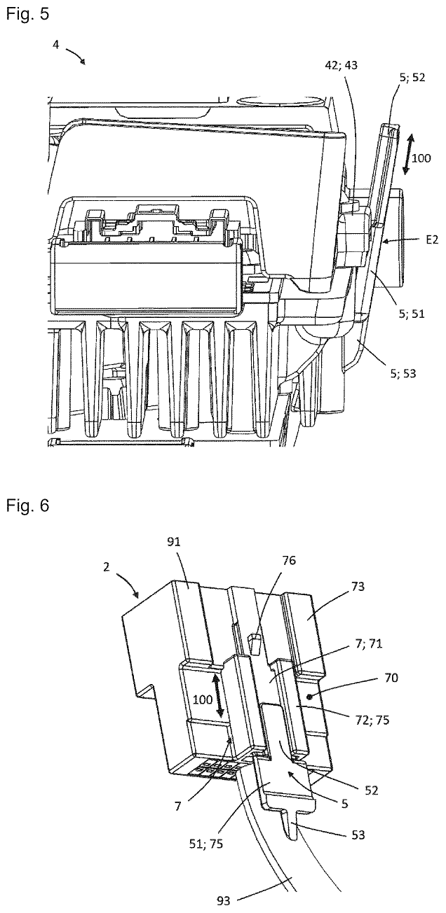

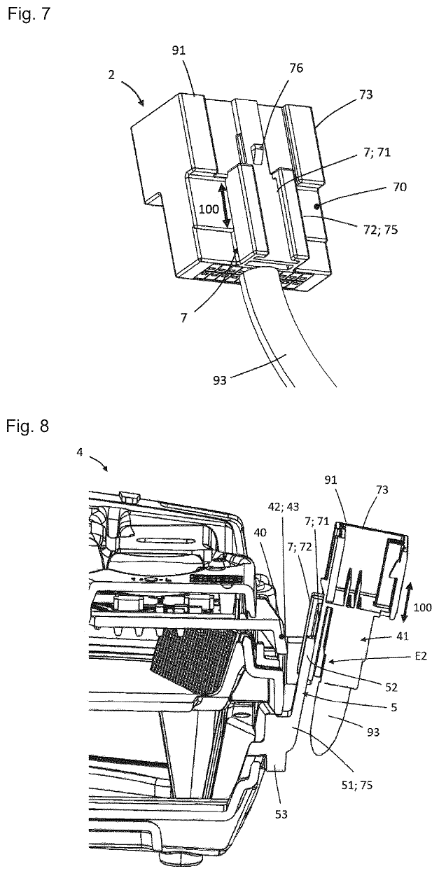

According to a preferred embodiment, the connection component 7 comprises a groove or a gutter 71 configured to receive the holding tab 5, notably at least the connection segment 52. The groove or gutter 71 notably allows the movement of the holding tab 5 to be held and guided relative to the electrical connection device 41, particularly relative to the primary connector 91. The primary connector 91 is thus preferably configured to be arranged on or removed from the holding tab 5 in a translational movement in a handling direction 100, illustrated in FIG. 5, FIG. 6, FIG. 7 and FIG. 8. Preferably, the groove or gutter 71 extends over a portion of the body 73, notably over a portion of one dimension of the body 71 extending from the connection end to the free end opposite the body 71.

By way of a non-limiting example, the connection component 7 comprises two guide means 72 projecting from an outer surface 70 of the body 73 of the connector and bordering or delimiting the gutter 71 or the groove. Such guide means 72 thus form ribs relative to the outer surface 70. Alternatively, the groove or gutter 71 can be formed by a groove defined in the body 73, either by molding or by removing material, for example, with a T-shaped profile.

Optionally, the holding tab 5 and/or the connection component 7 can comprise at least one stop element 75 configured to limit the movement of the primary connector 91 relative to the holding tab 5 in at least one way of a considered direction when they cooperate. For example, the guide means 72 can also act as stop elements 75 in one or more ways of a direction transverse to, or even orthogonal to, the handling direction 100.

According to another additional or alternative example, the base 51 can form a stop element 75. The base 51 then has at least one dimension, such as a thickness or a width, that is strictly greater than a dimension of the connection segment 52, so as to form a stop for the primary connector 91 in a way of the handling direction 100. In this case, the width of the base 51 is strictly greater than a width of the connection segment 52, with such dimensions in this case being defined in the longitudinal direction X. Such a principle advantageously allows, as illustrated in FIG. 8, the connector to be arranged at a non-zero distance from the support 42, notably in order to facilitate handling.

Again optionally, in order to simplify the handling of the primary connector 91 from and to the second position and to allow it to be inserted and removed with minimum effort, the primary connector 91 is configured to be mounted in the second position by sliding in a translational movement in the handling direction 100. Also, the holding tab 5 is configured so as to be devoid of a stop in at least one way of the handling direction 100 so that the resistance likely to be observed for inserting or removing the connector is negligible. For example, to this end, the connection segment 52, notably a free end of the connection segment 52 opposite the base 51, is flat or substantially flat.

Conversely, optionally but preferably, the primary connector 91 of the electrical connection device 41 is configured to be mounted in the first position by clipping so as to provide a connection between the electrical connection device 41 and the power source that is sufficient to prevent them from being unintentionally detached. Thus, the primary connector 91 and/or the electrical connection device 41 can, in a known manner, include a fixing component 76, such as a clip, configured to cooperate with a complementary component arranged in the vicinity of the first location E1, for example, in the luminous module 4 and/or in the plate 3. Notably, the body 73 of the connector is adapted so that the fixing component 76 extends at a non-zero distance from the connection component 7, allowing it to be held in the second position. For example, the connection component 7 and the fixing component 76 are arranged on distinct faces of the body 73 of the primary connector 91 and/or have distinct proximities relative to the free end of the body 73.

The holding tab 5 comprises a metal material and/or a plastic material, notably filled with glass fibers, such as polycarbonate, also known as PC, or polybutylene terephthalate, also known as PBT. The holding tab 5 thus has a stiffness that is adapted for stable holding of the primary connector 91 relative to the luminous module 4.

The holding tab 5 is connected to the support 42. Notably, according to a preferred embodiment, the holding tab 5 and the support 42 are integral. In other words, they form a one-piece assembly and cannot be disconnected from each other without being damaged or even destroyed. According to an alternative embodiment, not shown, the holding tab 5 can be attached and fixed to the support 42, for example, by welding or by means of a fixing means such as a screw.

As explained above, the support 42 is selected from the at least one reflector 44 or the at least one heat sink 43. Preferably, the holding tab 5 is arranged on a lateral part of the luminous module 4. In this case, the holding tab 5 is arranged on one of the lateral walls 43a of the at least one heat sink 43.

Notably, the position of the holding tab 5 is adapted so as to be arranged in the vicinity of a second location E2 located at a distance from the first location E1. Notably, the second location E2 of the holding tab 5 is advantageously adapted so that the holding tab 5 does not generate any additional bulk relative to the first location E1, to the luminous module 4 and/or relative to mechanical elements then involved in assembling the luminous module 4, such as support elements holding the luminous module 4 in position on the assembly line. According to one embodiment illustrated in FIG. 9, the first location E1 is located on a lower part of the module and the luminous module 4 is capable of being supported from below by mechanical elements, such as feet 9, when it is assembled, also, the second location E2 is arranged laterally within the luminous module 4, at a distance from the first location E1.

Also in this sense, the dimensions, the orientation and/or the incline of the holding tab 5 can be optimized.

Optionally, the holding tab 5 is oriented so as to allow access, notably a connection, to the primary connector 91 by a testing machine 8 in a first direction, when the primary connector is arranged in the second position, with the first direction being distinct from a second direction, corresponding to a direction for accessing the electrical connection device 41, more specifically the primary connector 91, when the primary connector is arranged in the first position. For example, in this case, access to the primary connector 91 arranged in the first position is granted in the longitudinal direction X, notably from the front. Access to the primary connector 91 arranged in the second position is provided in a distinct direction, for example, vertical or inclined relative to the vertical direction Z. In this case, such access is granted through the top of the luminous module 4. The base 51 of the holding tab 5 is positioned lower than the connection segment 52 in the longitudinal direction X and the connector is configured to be mounted thereon so that the free end of the body 73 is positioned higher than the connection end.

Optionally, as illustrated in FIG. 4, the holding tab 5 can be inclined relative to the support 42. The term “inclined” relative to the support 42 is understood to mean that all or part of the holding tab 5, for example, at least the connection segment 52, is inclined relative to an outer face 40 of the support 42, turned toward the outside of the luminous module 4, supporting said tab. Alternatively or additionally, the incline of the holding tab 5 can be assessed relative to the vertical direction Y and/or to the longitudinal direction X. According to a non-limiting embodiment, the holding tab 5 has an incline ranging between 0 to 60°, or even between 5 and 50° or even 10 and 45°, relative to the outer face 40 of the support 42, to the longitudinal direction X and/or to the vertical direction Z. As indicated above, such an incline prevents the support 42 from interfering with the electrical connection device 41, notably with the primary connector 91, or any machine capable of interacting with the primary connector, notably during the assembly phase, and limits, or even prevents, the generation of bulk by the holding tab 5. Thus, the dimensions of the luminous module 4 are not affected and they do not need to be adapted to allow said module to be positioned on the plate 3 of the headlamp 2. The holding tab 5 thus can be obtained by limiting the architectural modifications required to accommodate its presence within the luminous module 4 and the headlamp 2 aimed at preventing interference between parts.

In particular, the holding tab 5 is positioned, dimensioned and/or oriented so as to extend in a volume delimited by end points of the external structure delimiting the luminous module 4, so as to avoid generating any additional bulk relative to said structure. In the illustrated example, in a non-limiting manner, such an external structure comprises the support 42. In other words, on the scale of the luminous module 4, the end points delimiting said module in the longitudinal X, vertical Z and transverse Y directions are not included in the holding tab 5 but are included in one or more distinct elements forming the external structure.

Again optionally, the second location E2 is defined so that the holding tab 5 extends at a non-zero distance from the plate 3 when the luminous module 4 is mounted thereon and the headlamp 2 is assembled.

Thus, the holding tab 5 allows the primary connector 91 of the electrical connection device 41 to be temporarily positioned on the luminous module 4, notably in order to allow the testing machine 8 to be connected to and disconnected from the electrical connection device 41, and to do so in a precise and stable manner.

According to optional particular embodiments, the luminous module 4 can comprise a plurality of sub-modules 4a, 4b and 4c. Each sub-module 4a-4c comprises at least one luminous source configured to produce a sub-luminous beam. The sub-beams specific to the various sub-modules are configured to be superimposed, juxtaposed and/or selectively activatable.

The electrical connection device 41 is then adapted and can comprise, in addition to the primary connector 91, at least one secondary connector 92 configured to be connected to the at least one printed circuit board of one of the sub-modules 4a-4c. The primary connector 91 is connected to the at least one secondary connector 92 by means of at least one cable 93, or by a cable bundle 74, and is configured to be arranged in the first position or in the second position as described above, respectively in the vicinity of the first location E1, so as to be connected to the power source or in the vicinity of the second location E2, so as to cooperate with the holding tab 5. Furthermore, it is understood that the above description applies, mutatis mutandis, to such an electrical connection device 41, with the only considered difference being that the primary connector 91 is moved as described above, while the at least one secondary connector 92 retains a fixed position in the vicinity of the at least one printed circuit board.

For example, each sub-module 4a-4c can comprise a printed circuit board specific thereto, supporting the at least one luminous source of the considered sub-module. The electrical connection device 41 can then comprise a plurality of secondary connectors 92 each connected to the primary connector 91 by at least one cable 93. In the illustrated examples, the luminous module 4 comprises three sub-modules 4a-4c and three secondary connectors 92, each supplying one of the sub-modules. It is understood that such a number is by no means limiting.

The invention also relates to a method for assembling a luminous module 4 according to the invention. It is understood that said method optionally can be adapted, mutatis mutandis, as a function of the features of the considered luminous module 4 described above.

The method initially comprises the temporary, reversible positioning of the primary connector 91 of the electrical connection device 41 in the second position by cooperating between the holding tab 5 and the connection component 7. Notably, as indicated above, such cooperation occurs by inserting the primary connector 91 in a translational movement in the handling direction 100 toward the support 42. For example, the primary connector 91 is inserted simply by sliding. Notably, the holding tab 5 is inserted into the groove or gutter 71 of the connection component 7. According to a particular embodiment, the primary connector 91 is moved until it is in contact with at least one of the stop elements 75, such as the base 51 of the connector.

The method then comprises a phase of carrying out one or more tests, comprising at least one functional and/or photometric test, of the operation of the luminous module 4. This is achieved by connecting at least the testing machine 8 to the electrical connection device 41, particularly to the primary connector 91 arranged in the second position.

Optionally, the primary connector 91 arranged in the second position is accessed in a direction that is inclined relative to the support 42, to the longitudinal direction X and/or to the vertical direction Z.

Then, the method comprises moving the primary connector 91 of the electrical connection device 41 from the second position to the first position. The primary connector 91 is thus moved from the holding tab 5, or second location E2, to the first location E1. The primary connector 91 is removed from the holding tab 5 according to a principle that is the opposite of that described above with reference to its insertion. According to a particular embodiment, the primary connector 91 is held on the first location E1 by clipping.

Finally, the luminous module 4 is arranged on the plate 3 of the headlamp 2. The various electrical and mechanical connections are then made in a conventional manner.

It should be noted that the step of moving the primary connector 91 from the second position to the first position can be carried out partially or entirely before or after positioning the luminous module 4 on the plate 3. Also, such a step can be executed manually, by an operator or technician, or automatically.

The extension direction of the holding tab 5, as explained above, is preferably adapted in order to optimize the assembly method. Notably, the holding tab 5 is arranged at a distance from the first location E1, configured to receive the primary connector 91 when the primary connector is arranged in the first position, so as to facilitate the handling of the primary connector 91. For example, the holding tab 5 is advantageously arranged on a wall or a portion of the luminous module 4 distinct from a wall or a portion comprising the first location E1.

Again optionally, as illustrated in FIG. 3, the holding tab 5 can be configured so as to avoid generating additional bulk within the luminous module 4 and relative to the mechanical elements involved in the assembly line, such as the support elements, or feet 9 shown as dashed lines, holding the luminous module 4 in position or even the testing machine 8. For example, the holding tab 5 is arranged on a wall or a portion of the module distinct from a wall or a portion by which the luminous module 4 is held, for example, by the feet 9, during the assembly phase. Thus, when the luminous module 4 is supported from below, through contact with a lower part of the luminous module 4, the tab is arranged on a separate part, for example, a lateral part.

Optionally, the holding tab 5 is oriented so as to allow access, notably a connection, to the testing machine 8 in a first direction distinct from a second direction, corresponding to a direction for accessing the primary connector 91 when the primary connector is arranged in the first position. For example, in this case, the connection to the power source implemented when the primary connector 91 is in the first position is made in the longitudinal direction X, notably from the front, while the access, or the connection, to the primary connector 91 arranged in the second position is made in a distinct direction, for example, vertical or inclined relative to the vertical direction Z, for example, through the top of the luminous module 4.

Alternatively, such a principle can be applied so that access to the primary connector 91 made in the first position and in the second position occurs in opposite ways in the same direction. For example, for an electrical connection made from the rear when the connector is in the first position, access to the primary connector 91 arranged in the second position can be granted from the front of the module, or vice versa. The holding tab 5 can then extend forward, for example, in the longitudinal direction or so as to be partly inclined relative to the support 42 and to the longitudinal direction X. For example, the holding tab 5, and by extension access thereto, can have an incline ranging between 0 and 60°, or even between 5 and 50° or even 10 and 45°, relative to the outer face 40 of the support 42, the longitudinal direction X and/or the vertical direction Z.

It is understood that the present method applies, mutatis mutandis, to an electrical connection device 41 comprising at least one secondary connector 92 as described above.

Thus, the present invention proposes a luminous module comprising a holding tab allowing the electrical connection device to be temporarily and reversibly arranged in a position suitable for mounting the luminous module and for implementing tests. The holding tab is advantageously obtained in a simple manner, at a lower cost and without affecting the architecture of the luminous module or of a luminous device comprising said luminous module.

However, the present invention is not limited to the means and configurations described and illustrated herein, and also extends to any equivalent means or configuration and to any technically functional combination of such means provided that they ultimately perform the functions described and illustrated in the present document.

What is claimed is:

1. A luminous module for a luminous device for an automotive vehicle comprising:
at least one printed circuit board and at least one luminous source arranged on board;
at least one electrical connection device configured to be connected to the at least one printed circuit board and including a primary connector configured to be movable and arranged in a first operating position so as to be connected to a power source;
a support; and
a holding tab connected to the support and configured to reversibly hold the primary connector in a second position, distinct from the first position, notably during an assembly phase of the luminous module, the primary connector including a connection component configured to cooperate with the holding tab.

2. The luminous module as claimed in claim 1, wherein the holding tab is oriented so as to allow access, notably to the primary connector by a testing machine in a first direction when the primary connector is arranged in the second position,
the first direction being distinct from a second direction, corresponding to a direction for accessing the primary connector when the primary connector is arranged in the first position.

3. The luminous module as claimed in claim 1, wherein the connection component includes a groove or a gutter.

4. The luminous module as claimed in claim 1, wherein:
the holding tab and the support are integral; and/or
the luminous module includes at least one reflector and/or a heat sink, the support being selected from among the reflector or the heat sink. 3

5. The luminous module as claimed in claim 1, wherein the holding tab is inclined relative to the support.

6. The luminous module as claimed in claim 1, wherein:
the primary connector is configured to be mounted in the first position by clipping; and/or
the primary connector is configured to be mounted in the second position by sliding in a translation movement.

7. The luminous module as claimed in claim 1, with an external structure delimiting the luminous module, the holding tab being arranged and dimensioned so as to extend in a volume delimited by end points of the external structure so as to avoid generating any additional bulk relative to the structure.

8. The luminous module as claimed in claim 1, wherein the electrical connection device includes the primary connector, configured to be arranged in the first position or in the second position, and at least one secondary connector configured to be connected to the at least one printed circuit board and connected to the primary connector by means of at least one cable.

9. A luminous device for an automotive vehicle, comprising a luminous module and a plate configured to support at least the luminous module and to cooperate with a primary connector when the primary connector is arranged in the first position, with the luminous module including at least one printed circuit board and at least one luminous source arranged on the board, at least one electrical connection device configured to be connected to the at least one printed circuit board and including the primary connector configured to be movable and arranged in a first operating position so as to be connected to a power source, a support, and a holding tab connected to the support and configured to reversibly hold the primary connector in a second position, distinct from the first position, notably during an assembly phase of the luminous module, the primary connector including a connection component configured to cooperate with the holding tab.

10. (canceled)

11. A method for assembling a luminous module including at least one printed circuit board and at least one luminous source arranged on the board, at least one electrical connection device configured to be connected to the at least one printed circuit board and including the primary connector configured to be movable and arranged in a first operating position so as to be connected to a power source, a support, and a holding tab connected to the support and configured to reversibly hold the primary connector in a second position, distinct from the first position, notably during an assembly phase of the luminous module, the primary connector including a connection component configured to cooperate with the holding tab.
temporarily positioning the primary connector of the electrical connection device in the second position by cooperating between the holding tab and the connection component;
a phase of carrying out one or more functional and/or photometric tests of the operation of the luminous module by connecting a testing machine to the primary connector arranged in the second position;
moving the primary connector from the second position to the first position.
